(19) United States
(12) Patent Application Publication
(10) Pub. No.: US 2010/0246449 A1
(43) Pub. Date: Sep. 30, 2010

(54) SESSION REPLACEMENT USING REPLACED SESSION ATTRIBUTES

(75) Inventors: Sundaram Anantharaman, Redmond, WA (US); Calin M. Popa, Bothell, WA (US); Vinit C. Deshpande, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/414,685

(22) Filed: Mar. 31, 2009

(51) Int. Cl. H04L 12/16

(52) U.S. Cl. 370/261

(57) ABSTRACT

Architecture for session management enabling the reusing of session attributes of a current session in creating a new session, for adding new participants to a call session. A telephony component manages IP-based call sessions. The telephony component can be an IP telephone or a personal computing device running an IP telephony application, for example. A header component includes attributes of an existing IP call session with multiple parties. The header component can be sent in an INVITE message when establishing the new IP call session, for example. An attribute selection component selects attributes of the existing IP call session to be reused with the new IP call session with the multiple parties and a different party or parties. A session replacement component replaces the existing IP call session with the new IP call session, including the attributes reused from the previous session.

### BACKGROUND

In Internet protocol (IP) conference calling, multiple parties on a call can have one or more additional parties join the call. In order to add additional parties, an existing call session between the current parties is terminated and a new call session is initiated in which the current and additional parties are added. In order to establish the new session, properties of the new session are negotiated for all participants. Some participating session clients can be running different software versions or otherwise operating with different connectivity attributes. These various connectivity attributes are negotiated in order to establish a session that provides optimal support for all parties.

In IP telephony, a new, incoming session replaces an existing session by adding a “replaces” header in the incoming session INVITE, received by all participants. An INVITE with the “replaces” header is called an “INVITE-with-replaces” message and identifies the existing session that is being replaced. The new, incoming session is called the “replacing session” and the existing session is called the “replaced session.”

In establishing a new session, it can take several seconds for the negotiation to be completed and the new session to be established. This is inefficient and can result in awkwardness for the session participants. However, in certain instances, the properties of the new session can be similar to the properties of the old session, particularly if the participants are in the same enterprise and operating the same software versions and other connectivity properties. For example, properties such as the version of interactive connectivity establishment (ICE) or the type of connectivity (relay or direct) used by the participants do not change between the new session and the old established session.

Significant delays can be encountered when negotiating a new session for adding participants to a video teleconference. In escalating to video teleconferencing, particularly in certain proprietary applications, the escalation process is quite involved and includes many steps. As a result, the call setup time can be perceived as too long by the participants, resulting in further awkwardness and inefficiency.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, architecture is disclosed for replacing an existing session with a new session by including hints of the attributes used in the existing session to be reused in the new session. By reusing the attributes of a current session to create a new session, the new session does not have to re-establish or re-negotiate these attributes. Reusing the attributes of the current session significantly decreases the amount of time needed to configure a call setup time, decreasing the delay associated with adding new participants, and thereby improving efficiency and user experience.

For example, if participants in a call are using a specific version of ICE or a particular type of connectivity, reusing the associated session attributes from the previous session reduces the time spent negotiating and establishing the new session. The call participants can then add new callers without an awkward delay, thereby improving performance and providing a reassuring perception of system operation to the call participants.

In particular, when a new person joins the conference, a header is sent including an “INVITE-with-replaces” message having information about the session scenario and the attributes that can be reused by the target session. For example, the ICE properties negotiated between a remote party and a specific proprietary phone device can be reused when migrating the call to another system having similar network characteristics.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented system for performing session management.

FIG. 2 illustrates additional aspects of the session management system.

FIG. 3 illustrates further aspects of the session management system, particularly when adding a different party to a multiple party call.

FIG. 4 illustrates further additional aspects of the session management system as used particularly for video teleconferencing.

FIG. 5 illustrates additional aspects of the attributes that can be included in a header.

FIG. 6 illustrates an alternative embodiment of the computer-implemented system for performing session management.

FIG. 7 illustrates additional aspects of a header component.

FIG. 8 illustrates a method of session management.

FIG. 9 illustrates further aspects in the method of session management of FIG. 8.

FIG. 13 illustrates a block diagram of a computing system operable to execute the session management in accordance with the disclosed architecture.

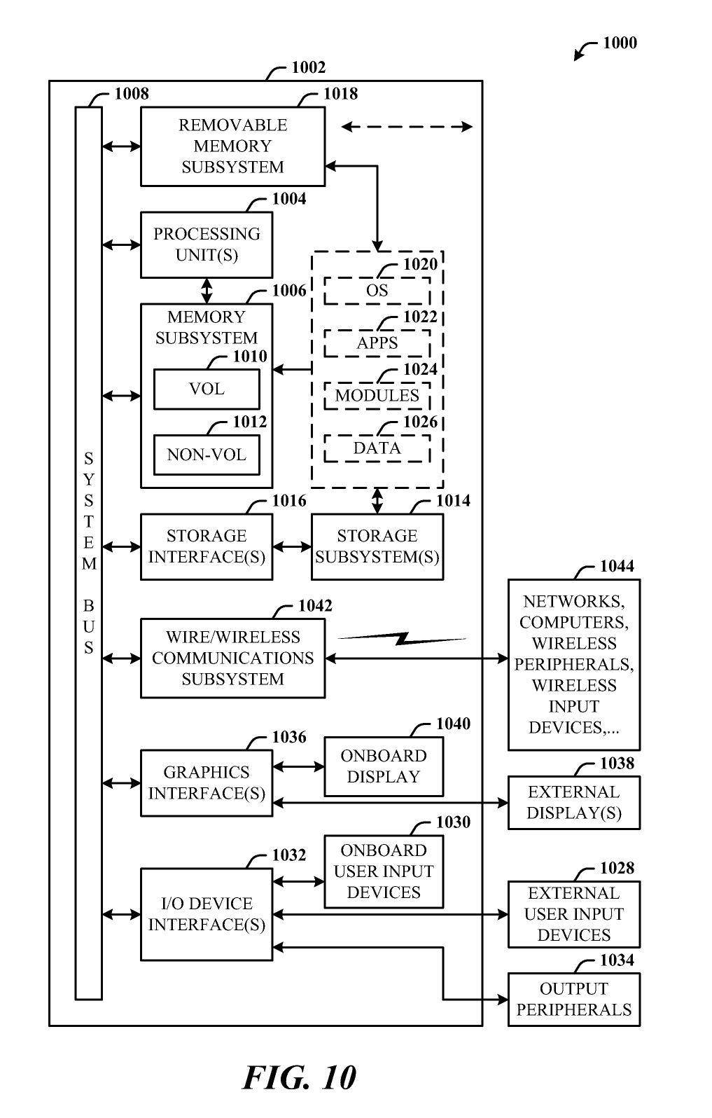

FIG. 14 illustrates an exemplary computing environment operable to provide session management.

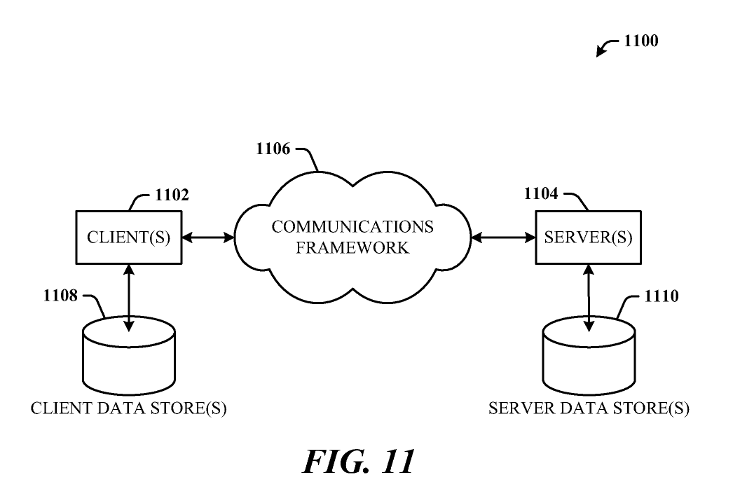

### DETAILED DESCRIPTION

The disclosed architecture provides session management enabling the reusing of session attributes of a current session in creating a new session, for adding new participants to a call session. A telephony component manages IP-based call sessions. The telephony component can be an IP telephone or a personal computing device running an IP telephony application, for example. A header component includes attributes of an existing IP call session with multiple parties. The header component can be sent in an INVITE message when establishing the new IP call session, for example. An attribute selection component selects attributes of the existing IP call session to be reused with the new IP call session with the multiple parties and a different party or parties. A session replacement component replaces the existing IP call session with the new IP call session, including the attributes reused from the previous session.

The header component can employ a grammar that specifies a hint via a comma-separated string. The hint can indicate attributes of the existing IP call session that can be optionally reused in the new IP call session. The system can selectively use the hint in selecting new attributes, or can optionally disregard the hint and create a new session using renegotiated session attributes. The attributes can include ICE (interactive connectivity establishment) properties, or types of connectivity, including relay connectivity or direct connectivity, for example. The session management system can be used for any type of IP call session, but has particular applicability to video teleconferencing sessions, for example, in which renegotiation delays can present a significant delay.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

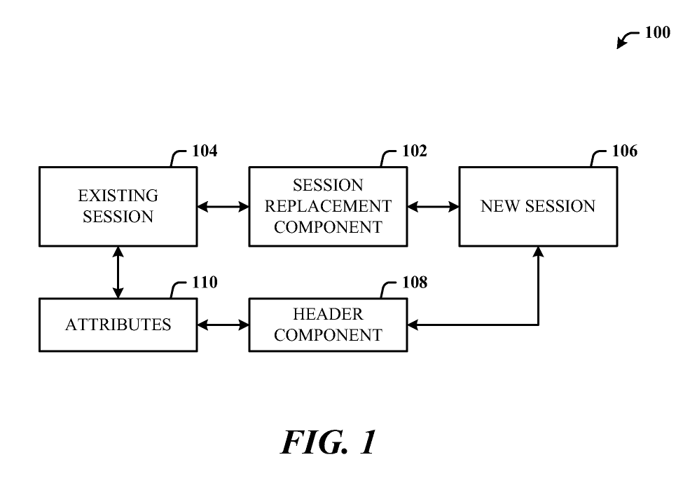

FIG. 1 illustrates a computer-implemented system 100 for performing session management by providing hints in accordance with the disclosed architecture. The system 100 includes a session replacement component 102 for replacing an existing session 104 with a new session 106. A header component 108 hints the use of one or more attributes 110 of the existing session 104 in the new session 106. In this manner, the system 100 enables the attributes 110 of the existing session 104 to be selectively reused, thereby allowing the new session 106 to be created quickly and without an awkward delay, thus resulting in improved performance, greater efficiency, and an enhanced experience for session participants.

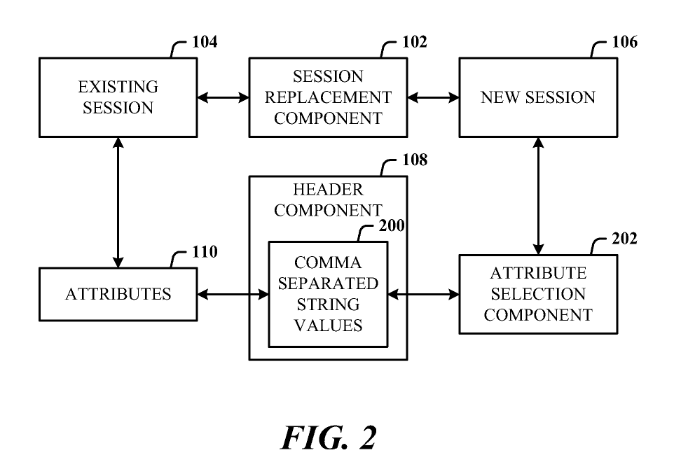

FIG. 2 illustrates additional aspects of the session management system 100 of FIG. 1. The header component 108 can include comma-separated string values 200 for hinting the use of the attributes 110. The attributes 110 in the string values 200 are read as hints to selectively determine whether to reuse particular attributes from the existing session 104 in creating the new session 106. An attribute selection component 202 can optionally select one or more of the attributes 110 to reuse in replacing the existing session 104 with the new session 106.

Reusing the hinted attributes 110 can enable rapid replacement of the existing session 104 with the new session 106. However, the system 100 can also determine whether the new attributes 110 provide adequate performance for all session participants upon adding a new session participant. Thus, the system 100 can reuse certain attributes from the existing session 104 but negotiate for additional attributes to establish a desired connection, for adding participants running legacy clients or non-compatible clients, for example. In such instances, the interval for establishing the new session can be reduced since some attributes are being reused. Alternatively, it can be determined that no attributes can be reused, if the new session participant shares no attributes from the existing session 104, for example. In such instances, the system 100 can optionally select to not reuse any of the attributes 110 of the existing session 104 and completely renegotiate the new session 106.

In one implementation, the header component 108 can be used in an IP telephony system in which hints about session attributes can be reused to improve performance of call setup. The header component 108 can facilitate session replacement via a SIP (session initiation protocol) message. In initiating the new session 106, the header component 108 is employed as a SIP “INVITE-with-replaces” message and includes values that identify attributes that can be reused. The header component 108 can be called “ms-replace-hint,” for example, and has a grammar including comma-separated string values 200 where each token specifies a hint corresponding to one of the attributes 110 of the existing session 104. The header component 108 can include possible values of ICE, in which the established ICE properties can be reused and thus need not be re-established in the new session 106.

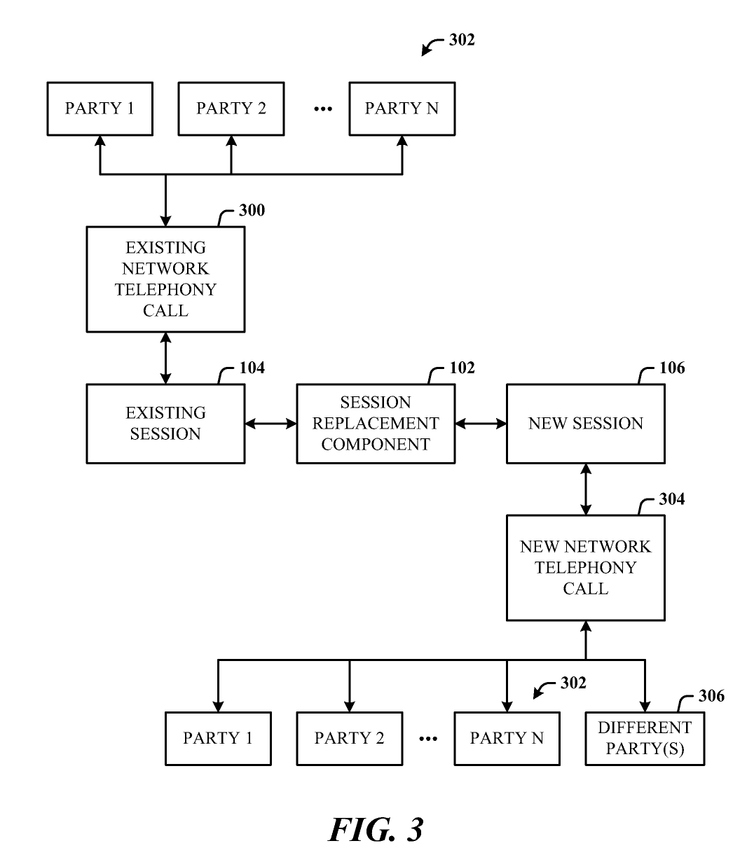

FIG. 3 illustrates further aspects of the session management system 100 of FIG. 1, particularly when adding a different party to a multiple party call. The existing session 104 can include an existing network telephony call 300 (e.g., IP call) that includes multiple parties 302. The new session 106 can include a new network telephony call 304 that includes the multiple parties 302 and also one or more different party(s) 306. The session replacement component 102 replaces the existing network telephony call 300 with the new network telephony call 304. It is to be appreciated that the different party(s) 306 can include multiple different parties to be added to the new network telephony call 304. Additionally, one or more of the initial multiple parties 302 can be dropped before or during the new network telephony call 304.

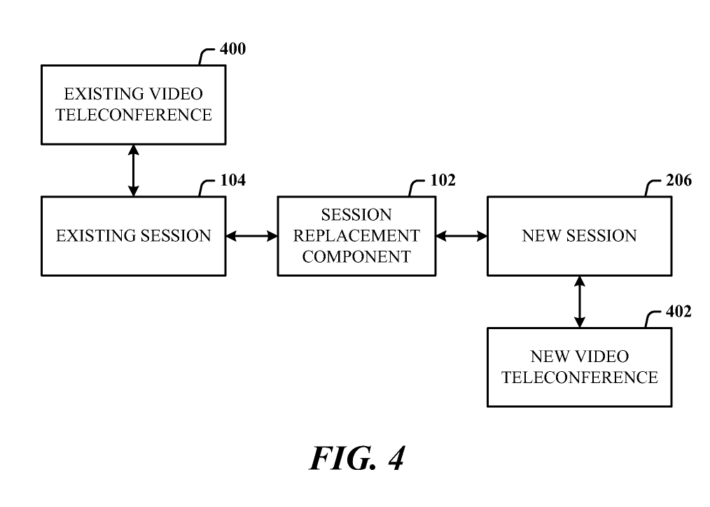

FIG. 4 illustrates further additional aspects of the session management system 100 of FIG. 1 as used particularly for video teleconferencing. The existing session 104 includes an existing video teleconference 400 and the new session 106 includes a new video teleconference 402. The session replacement component 102 replaces the existing video teleconference 400 with the new video teleconference 402. By reusing attributes of the existing video teleconference 400 in the new video teleconference 402, the delays associated with renegotiation can be greatly reduced, resulting in improved efficiency and an enhanced experience for the video teleconference participants.

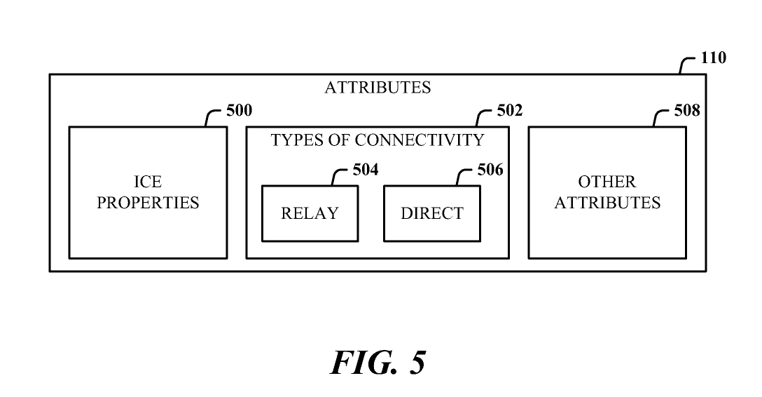

FIG. 5 illustrates additional aspects of the attributes 110 that can be included in the header component 108 of FIG. 1. As illustrated, the attributes 110 can include properties that do not change between the existing session 104 and the new session 106. The attributes 110 can include ICE properties 500, for example, the version of ICE used in the existing session 104. The attributes 110 can also include the types of connectivity 502, such as relay connectivity 504 and/or direct connectivity 506, for example. The attributes 110 can also include other attributes 508, such as any properties of the connection or any components associated therewith.

By reusing the attributes 110, the new session 104 does not have to reestablish or renegotiate attributes such as ICE version or connectivity type, and thus, greatly decreases call setup time under those circumstances. Further to an aforementioned example, if the ICE version is presented as a string value in the header component 108, this string value enables a recipient of the SIP “INVITE-with-replaces” message to identify the ICE version and connectivity type used in the established session. The recipient of the “INVITE-with-replaces” message can use these attribute values as a hint for establishing the new session 106 and thereby decrease call setup time.

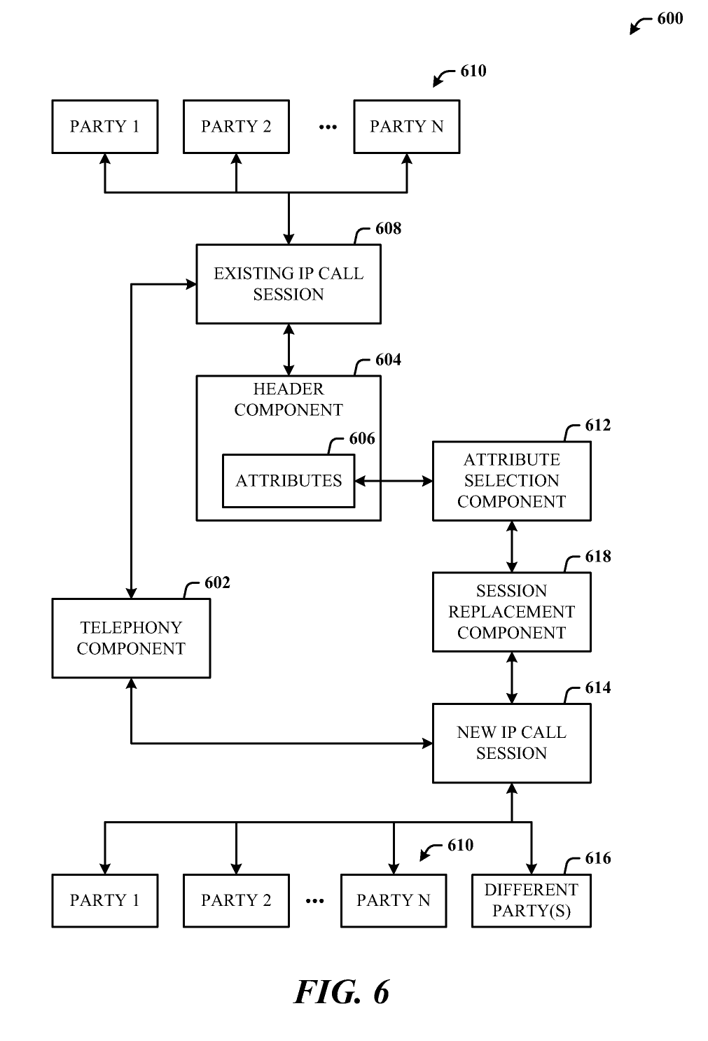

FIG. 6 illustrates an alternative embodiment of a computer-implemented system 600 for performing session management. A telephony component 602 is provided for managing IP-based call sessions. A header component 604 includes attributes 606 of an existing IP call session 608, which includes multiple parties 610. The multiple parties 610 can be engaged in a direct phone call between two parties, for example. Alternatively, the multiple parties 610 can be engaged in a conference call between more than two participants. It is also to be appreciated that the IP call sessions can be or include video teleconferencing sessions.

As illustrated in FIG. 6, an attribute selection component 612 selects one or more of the attributes 606 of the existing IP call session 608 to be reused with a new IP call session 614. The new IP call session 614 can include some or all of the multiple parties 610 and one or more different party(s) 616. This can represent a scenario where a session with two call participants can add a third participant to the call. Alternatively, a session can be contemplated in which one or more participants can add one or more additional participants to the call. It is to be appreciated that one or more original participants can also drop from the call, without impacting on the selection of the attributes 606 to be reused in the new IP call session 614. A session replacement component 618 replaces the existing IP call session 608 with the new IP call session 614.

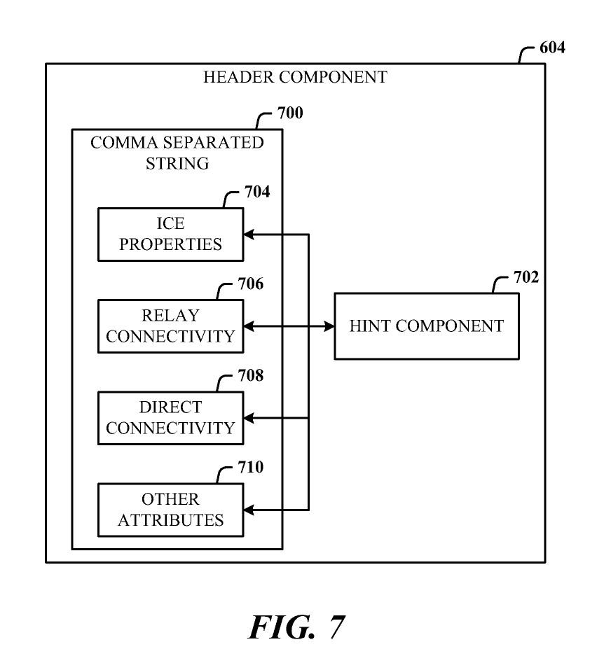

FIG. 7 illustrates additional aspects of the header component 604 of FIG. 6. The header component 604 (similar to header component 108 of FIG. 1) can employ a grammar that specifies a hint via a comma-separated string 700. Further, a hint component 702 can be used for indicating optional attributes of the existing IP call session 608 to reuse in the new IP call session 614. Alternatively, the values of the string 700 can optionally be disregarded in establishing the new session 614. The attributes 606 (similar to attributes 110 of FIG. 1) in the common separated string 700 can include ICE properties 704 and also types of connectivity that can be optionally selected, including relay connectivity 706 and direct connectivity 708. Additionally, other attributes 710 can be included as hints the comma separated string 700, including any attributes that serve to establish the new IP call session 614.

In the existing and new IP call sessions (608 and 614), a SIP “INVITE-with-replaces” message can be used and includes a hint portion, as described in a previous embodiment hereinabove. The SIP “INVITE-with-replaces” message includes sufficient information about the existing IP call session 608 so that the attributes 606 can be reused by the target in the new IP call session 614. For example, ICE properties that can be negotiated between a remote party and a specific IP phone component can be reused when migrating the call to include a similar application since the entities have similar network characteristics.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

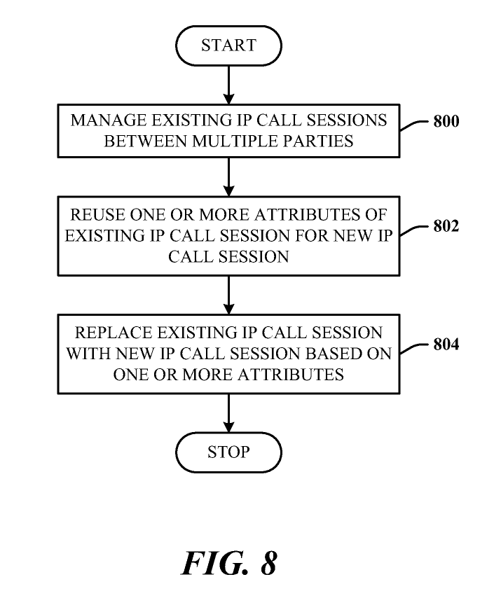

FIG. 8 illustrates a method of session management. At 800, an existing IP call session between multiple parties is managed. At 802, one or more of the attributes of the existing IP call session are reused for a new IP call session. At 804, the existing IP call session is replaced with the new IP call session based on the one or more attributes. In this manner, a time savings is realized in establishing the new IP call session, since the reused attributes do not need to be renegotiated. Thus, efficiency is improved and the user experience is enhanced for the participants of the IP call.

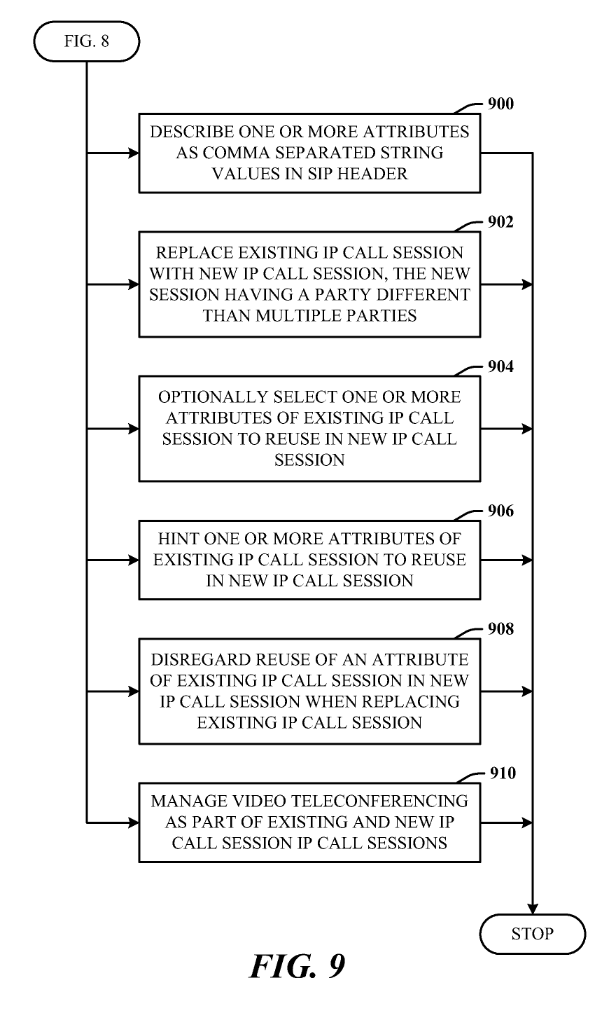

FIG. 9 illustrates further aspects in the method of session management of FIG. 8. At 900, the one or more attributes are described as comma-separated string values in a SIP header. At 902, the existing IP call session is replaced with the new IP call session, the new IP call session having a party different than the multiple parties. At 904, the one or more attributes of the existing IP call session are optionally selected to reuse in the new IP call session. At 906, the one or more attributes of the existing IP call session are hinted for use in the new IP call session via a SIP header. At 908, the reuse of an attribute of the existing IP call session can be disregarded in the new IP call session when replacing the existing IP call session. At 910, video teleconferencing is managed as part of the existing IP call session and new IP call session. In this manner, the time normally interval required for adding new participants to an audio or video call is reduced, improving performance and efficiency.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

Referring now to FIG. 10, there is illustrated a block diagram of a computing system 1000 operable to execute session management in accordance with the disclosed architecture. In order to provide additional context for various aspects thereof, FIG. 10 and the following discussion are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the memory subsystem 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes storage subsystem(s) 1014 and storage interface(s) 1016 for interfacing the storage subsystem(s) 1014 to the system bus 1008 and other desired computer components. The storage subsystem(s) 1014 can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The aforementioned application programs 1022, program modules 1024, and program data 1026 can include the computer-implemented session management system 100, the session replacement component 102, the existing session 104, the new session 106, the header component 108, and the attributes 110 of FIG. 1, the comma-separated string values 200 and the attribute selection component 202 of FIG. 2, the existing network telephony call 300, the multiple parties 302, the new network telephony call 304, and the different party 306 of FIG. 3, the existing video teleconference 400 and the new video teleconference 402 of FIG. 4.

The aforementioned application programs 1022, program modules 1024, and program data 1026 can further include the interactive connectivity establishment properties 500, the types of connectivity 502, the relay connectivity 504, the direct connectivity 506, and the other attributes 508 of FIG. 5, the computer-implemented session management system 600, the telephony component 602, the header component 604, the attributes 606, the existing IP call session 608, the multiple parties 610, the attribute selection component 612, the new IP call session 614, the different parties 616, and the session replacement component 618 of FIG. 6, the comma-separated string 700, the hint component 702, the ICE properties 704, the relay connectivity 706, the direct connectivity 708, and the other attributes 710 of FIG. 7, and the methods represented by the flow charts of FIGS. 8-9, for example.

The storage subsystem(s) 1014 and memory subsystems (1006 and 1018) serve as computer readable media for volatile and non-volatile storage of data, data structures, computer-executable instructions, and so forth. Computer readable media can be any available media that can be accessed by the computer 1002 and includes volatile and non-volatile media, removable and non-removable media. For the computer 1002, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP) using logical connections via a wired/wireless communications subsystem 1042 to one or more networks and/or other computers. The other computers can include workstations, servers, routers, personal computers, microprocessor-based entertainment appliance, a peer device or other common network node, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or has other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

Referring now to FIG. 11, there is illustrated a schematic block diagram of a computing environment 1100 that can be used for session management. The environment 1100 includes one or more client(s) 1102. The client(s) 1102 can be hardware and/or software (e.g., threads, processes, computing devices). The client(s) 1102 can house cookie(s) and/or associated contextual information, for example.

The environment 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The environment 1100 includes a communication framework 1106 (e.g., a global communication network such as the Internet) that can be employed to facilitate communications between the client(s) 1102 and the server(s) 1104.

Communications can be facilitated via a wire (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented session management system, comprising:
a session replacement component for replacing an existing session with a new session; and
a header component for hinting use of attributes of the existing session in the new session.

2. The system of claim 1, wherein the header component employs comma-separated string values of the header component for hinting the use of attributes.

3. The system of claim 1, further comprising an attribute selection component for optionally selecting at least one of the attributes to use in replacing the existing session with the new session.

4. The system of claim 1, further comprising an existing network telephony call of the existing session that includes multiple parties and a new network telephony call of the new session that includes the multiple parties and a different party.

5. The system of claim 1, wherein the existing session includes an existing video teleconference and the new session includes a new video teleconference.

6. The system of claim 1, wherein the attributes further comprise at least one of interactive connectivity establishment properties or types of connectivity.

7. The system of claim 1, wherein the header component further comprises a header that identifies the attributes of the existing session to be reused in the new session to facilitate session replacement, the header communicated via a SIP (session initiation protocol) message.

8. A computer-implemented session management system, comprising:
a telephony component for managing IP-based call sessions;
a header component for including attributes of an existing IP call session with multiple parties;
an attribute selection component for selecting at least one of the attributes of the existing IP call session to be reused with a new IP call session with the multiple parties and at least one different party; and
a session replacement component for replacing the existing IP call session with the new IP call session.

9. The system of claim 8, wherein the header component employs a grammar that specifies a hint via a comma-separated string.

10. The system of claim 8, wherein the IP call session includes a video teleconferencing session.

11. The system of claim 8, further comprising a hint component for indicating optional attributes of the existing IP call session to reuse in the new IP call session.

12. The system of claim 8, wherein the attributes further comprise interactive connectivity establishment properties.

13. The system of claim 8, wherein the attributes further comprise at least one of relay connectivity or direct connectivity.

14. A computer-implemented method of session management, comprising:
managing an existing IP call session between multiple parties;
reusing one or more attributes of the existing IP call session for a new IP call session; and
replacing the existing IP call session with the new IP call session based on the one or more attributes.

15. The method of claim 14, further comprising describing the one or more attributes as comma-separated string values in a SIP header.

16. The method of claim 14, further comprising replacing the existing IP call session with the new IP call session, the new IP call session having at least one party different than the multiple parties.

17. The method of claim 14, further comprising optionally selecting the one or more attributes of the existing IP call session to reuse in the new IP call session.

18. The method of claim 14, further comprising hinting the one or more attributes of the existing IP call session to reuse in the new IP call session via a SIP header.

19. The method of claim 14, further comprising disregarding reuse of an attribute of the existing IP call session in the new IP call session when replacing the existing IP call session.

20. The method of claim 14, further comprising managing video teleconferencing as part of the existing IP call session and the new IP call session.
